(19) United States
(12) Patent Application Publication
(10) Pub. No.: US 2026/0292873 A1
(43) Pub. Date: Sep. 24, 2026

(54) METHOD AND APPARATUS FOR RESOURCE RE-EVALUATION AND PRE-EMPTION USING COT MODIFICATION

(71) Applicant: InterDigital Patent Holdings, Inc., Wilmington, DE (US)

(72) Inventors: Tuong HOANG, Montreal (CA); Tao DENG, New York, NY (US); Moon IL LEE, Melville, NY (US); Aata EL HAMSS, Laval (CA); Martino FREDA, Laval (CA); Hesham MOHAMMED, Dallas, TX (US); Virgile Garcia, Antibes (FR)

(73) Assignee: InterDigital Patent Holdings, Inc., Wilmington, DE (US)

(21) Appl. No.: 19/472,318

(22) PCT Filed: Apr. 4, 2024
(86) PCT No.: PCT/US2024/023117

§ 371 Date: Oct. 3, 2025

Related U.S. Application Data
(60) Provisional application No. 63/456,986, filed on Apr. 4, 2023.

(51) Int. Cl. H04W 74/0808

(52) U.S. Cl. CPC H04W 74/0808

(57) ABSTRACT

Methods and apparatus are described. A wireless transmit/receive unit (WTRU) includes a processor and a transceiver reserve a first channel occupancy time (COT) for a transmission and detect whether a second COT reservation exists for another WTRU during the reserved first COT. The processor and the transceiver modify the first COT based on the WTRU detecting the second COT reservation during the reserved first COT. The processor and the transceiver also perform listen-before-talk (LBT) and transmission in the first COT.

### CROSS-REFERENCE TO RELATED APPLICATIONS

This application claims the benefit of U.S. Provisional Application No. 63/456,986 filed Apr. 4, 2023, the contents of which are incorporated herein by reference.

### SUMMARY

Methods and apparatus are described. A wireless transmit/receive unit (WTRU) includes a processor and a transceiver reserve a first channel occupancy time (COT) for a transmission and detect whether a second COT reservation exists for another WTRU during the reserved first COT. The processor and the transceiver modify the first COT based on the WTRU detecting the second COT reservation during the reserved first COT. The processor and the transceiver also perform listen-before-talk (LBT) and transmission in the first COT.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a diagram showing an example of pre-emption in R16 NR V2X;

FIGS. 3A, 3B, 3C and 3D are diagrams showing an example where a WTRU may determine whether COT2 blocks COT1 in LBT and transmission;

FIG. 4 is a diagram of an example of a WTRU shortening its reserved COT to avoid blocking LBT and transmission of another higher priority COT by another WTRU;

FIG. 5 is a diagram of another example of a WTRU shortening its reserved COT because another COT blocks its LBT and transmission in the reserved COT;

FIG. 6 is a diagram of an example of the first or second WTRU shifting its reserved COT to align with the reserved COT of the other WTRU;

FIG. 7 is a diagram showing an example of a WTRU determining to share its reserved COT with another WTRU if inter-COT blocking with the WTRU is detected;

FIG. 8 is a diagram of an example of a WTRU performing periodic COT reservation; and

FIG. 9 is a flow diagram of another example method of performing resource re-evaluation and/or pre-emption.

### DETAILED DESCRIPTION

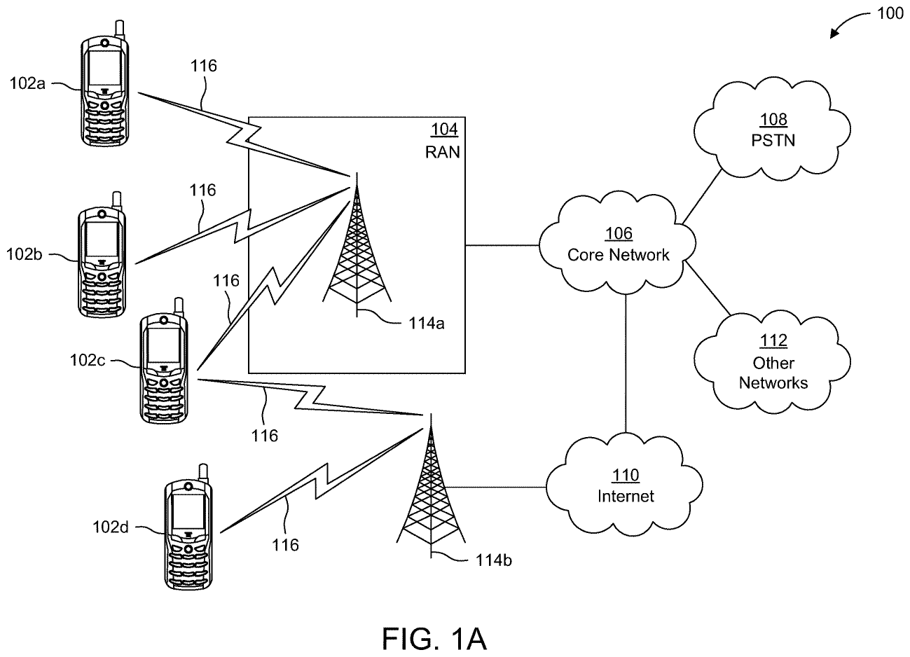

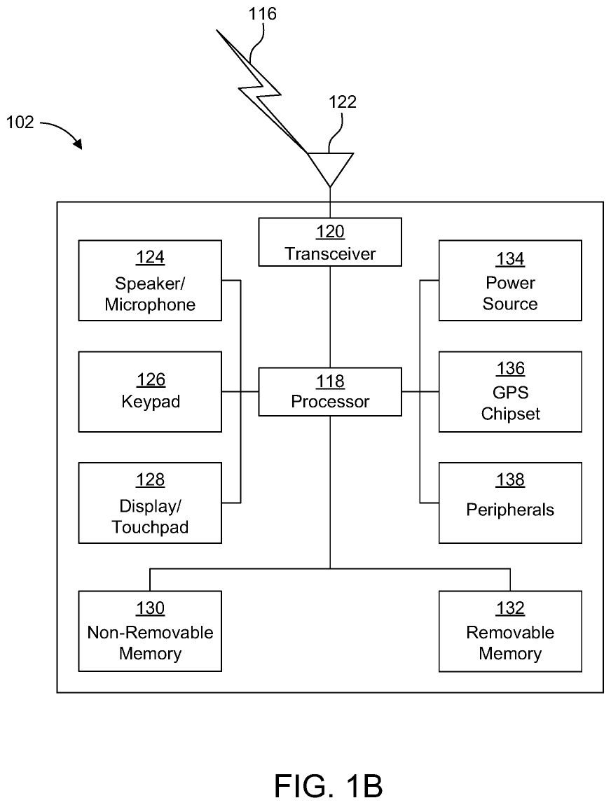

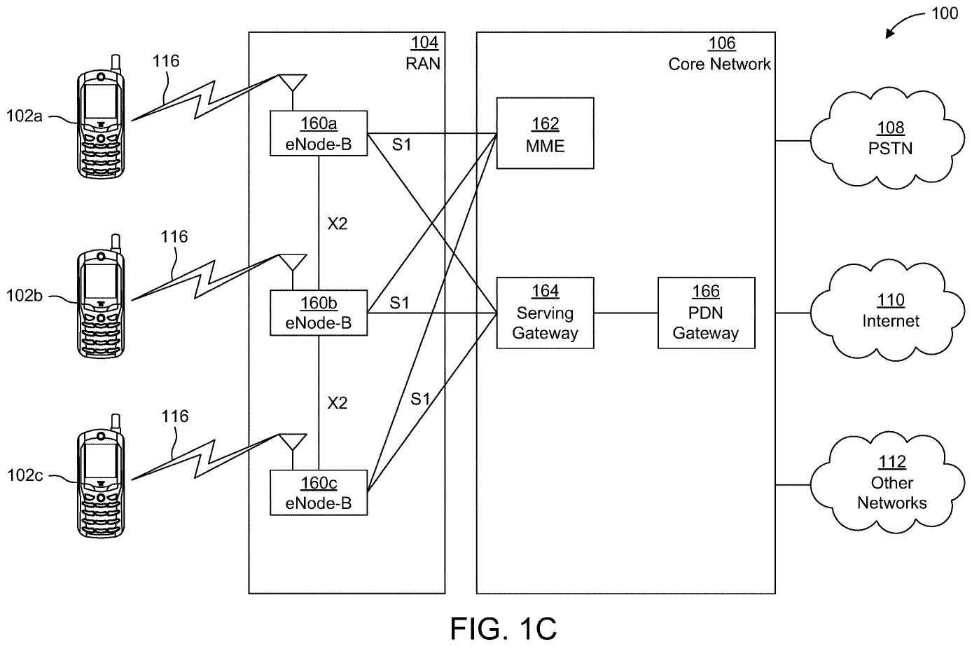

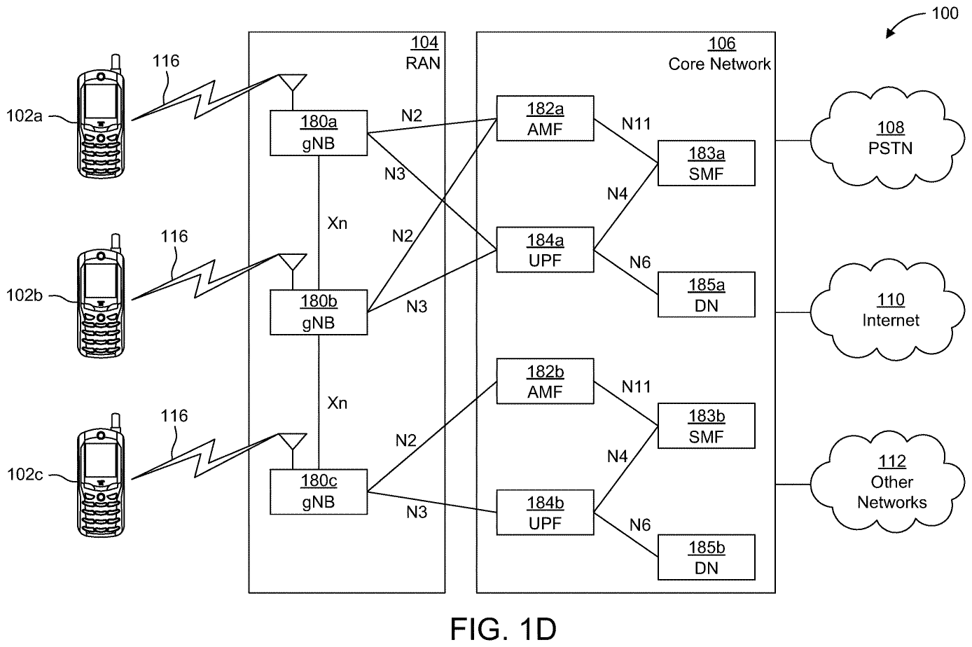

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB) In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114 b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In Release 16 (R16) New Radio (NR) V2X, pre-emption and resource re-evaluation may be used to help the WTRU minimize resource collision in its transmission resource. Pre-emption may be used to evaluate whether the WTRU's reserved resource is still available, and resource re-evaluation may be used to evaluate whether the WTRU's preselected resource is still available. Using both pre-emption and re-evaluation, the WTRU may reselect the reserved/preselected resource if it determines that the reserved/preselected resource is no longer available for transmission, such as because another WTRU with a higher priority reserved the same resource. The pre-emption and re-evaluation procedures are similar except they are applicable to two different types of resources: pre-emption is applicable for a reserved resource, and re-evaluation is applicable for a pre-selected resource, as previously mentioned.

For pre-emption for R16 NR V2X, the WTRU can be configured to enable/disable pre-emption in a resource pool. If pre-emption is enabled, the WTRU may be further configured with a highest priority value of transmission from another WTRU, which may determine whether the WTRU is permitted to pre-empt the other WTRU's transmission. For example, only a transmission from a WTRU with a priority value smaller than the configured or pre-configured threshold can pre-empt a transmission from the other WTRU (having a higher priority value).

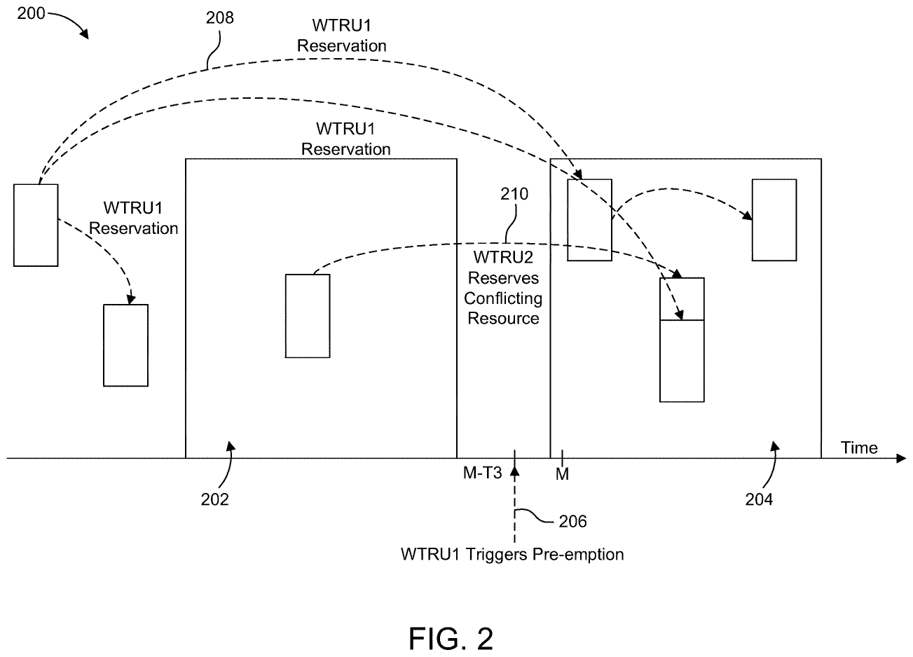

FIG. 2 is a diagram 200 showing an example of pre-emption in R16 NR V2X. In the example illustrated in FIG. 2, a first WTRU (WTRU1) makes a reservation 208 for reserved resources for a transmission in slot m (204). A second WTRU (WTRU2) may interpedently make a reservation. In the example illustrated in FIG. 2, the WTRU2 makes a conflicting reservation 210 in slot m (204). The WTRU1 may perform pre-emption checking at slot m-T3 (202) to determine whether the reserved resource collides with any higher priority transmission. If collision with the higher priority transmission happens (e.g., the reserved resource is not in SA), the WTRU may reselect another resource from the new SA. In the illustrated example, the WTRU1 detects the conflicting reservation in slot m (204) by performing pre-emption checking at slot m-T3 (202) and, based on the detection, the WTRU1 triggers pre-emption (206) in a gap between the end of slot m-T3 (202) and the beginning of slot m (204).

In NR Unlicensed (NR U), a WTRU can access a channel for UL transmission according to Type 1 or Type 2 UL channel access procedures. These procedures are designed for compliance with the regulatory requirements related to, for example, sensing (listen-before-talk (LBT)), maximum Channel Occupancy Time (mCOT), Occupied Channel Bandwidth (OCB) and Power Spectral Density (PSD). A Type 1 channel access procedure may include LBT sensing with random back-off and a variable extended clear channel assessment (CCA) period based on a contention window. The size of the contention window may be selected based on a Channel Access Priority Class (CAPC) configuration. A gNB or WTRU must perform a Type 1 channel access procedure to initiate a channel occupancy time (COT). Type 2A channel access and type 2B channel access may be performed when the transmission gap is 25 μs and 16 μs, respectively. When a transmission gap is smaller than 16 μs, type 2C channel access may be used with an immediate transmission after the gap without performing sensing.

For DL transmissions in NR U, a WTRU may use COT structure indication, dynamic PDCCH monitoring and flexible PDSCH starting positions because of the uncertainty caused by LBT. For UL control and data channel transmissions, to comply with the OCB requirement, new block interlaced-based transmissions may be used for PUCCH and PUSCH transmissions with flexible starting positions for PUSCH. NR U sounding reference signal (SRS) transmissions may be enhanced with additional flexibility for configuration and triggering. In addition, NR U supports a frame structure with multiple DL-to-UL and UL-to-DL switching points within a shared COT.

In SL-U, it is expected that a WTRU may perform either single-slot-based transmission or Multi Consecutive Slot based transmission (MCSt). Slot-based transmission has been adopted in NR V2X, in which transmissions (e.g., one initial transmission and multiple retransmissions) of each transport block (TB) may be scattered in different, and not necessarily contiguous, time slots. MCSt allows the WTRU to perform multiple transmissions of one or multiple TBs contiguously. This approach allows the WTRU to maintain the COT and minimize the overhead of the LBT procedure.

Different from NR V2X, in Sidelink-Unlicensed (SL U), the WTRU is required to perform LBT before accessing the channel. If the channel is not cleared before the resource timing, the WTRU is not allowed to perform transmission in the resource. The WTRU is required to perform type 1 LBT to initialize the COT and type 2 LBT to share the COT with other WTRUs. For COT sharing, the WTRU may be allowed to share the COT with another WTRU if the COT initiator WTRU is one of the receivers. Alternatively, it is expected that the WTRU may be allowed to share the COT if the COT initiator allows the WTRU to share the COT by indicating its ID in its transmission (e.g., sidelink control information (SCI)).

It is expected that resource re-evaluation and pre-emption will be supported in SL U to reduce resource collision among SL U users. However, the resource re-evaluation and pre-emption procedures need to consider specific properties of SL U, such as LBT, MCSt, and COT sharing. Embodiments described herein provide various solutions for performing resource re-evaluation and pre-emption for SL U.

In some embodiments, whether a WTRU triggers resource re-selection for a reserved resource in a slot may be based on the availability of a gap duration, which is greater than a configured or pre-configured threshold, before the reserved slot. The WTRU may be configured or pre-configured with a GAP threshold, which may be used to determine whether the WTRU has enough time for LBT before transmission in a reserved COT. The WTRU may perform sidelink transmission to reserve a COT (e.g., in sidelink control information (SCI)) for its transmission in the future (e.g., periodic COT reservation). The WTRU may perform sensing before its reserved COT by decoding SCI from another WTRU (e.g., to detect a COT reservation). The WTRU may trigger pre-emption checking to determine the availability of the reserved COT. If there is a COT reservation from another WTRU before its reserved COT, the WTRU may determine the time gap between the end of the other WTRU's reserved COT and the first symbol of its reserved COT. If the time gap is larger than the GAP threshold, the WTRU may perform LBT and transmission in the reserved COT. If the time gap is smaller than the GAP threshold, the WTRU may trigger resource reselection to select another resource in another slot to transmit data. Otherwise, if there is no COT reservation before its reserved COT, the WTRU may perform LBT and transmission in the reserved COT.

In some embodiments, the WTRU may modify its reserved COT to perform LBT and transmission based on collision detection with a higher priority transmission of another WTRU within the COT, in which the WTRU may determine to either shift or shorten its COT based on the remaining COT duration. The WTRU may perform sidelink transmission to reserve a COT (e.g., in SCI) for its transmission in the future (e.g., periodic COT reservation). The WTRU may perform sensing before its reserved COT (e.g., to detect COT reservations from other WTRUs). The WTRU may trigger pre-emption checking to determine the availability of the reserved COT. If there is another WTRU reserving a higher priority COT colliding with its reserved COT, the WTRU may modify its COT to perform LBT and transmission. If the remaining COT (e.g., without considering the colliding slots) is greater than a threshold, the WTRU may shorten its COT by releasing the colliding slots. The WTRU may then perform LBT and transmission in the shortened COT and reserve another COT for data transmission. Otherwise, the WTRU may shift its COT starting time to align with the COT of the other WTRU. If the reserved interlace collides with the other WTRU, the WTRU may re-select another interlace. The WTRU may perform LBT and transmission in the shifted COT. Otherwise, the WTRU may perform LBT and transmission in the reserved COT.

In some embodiments, the WTRU may share its COT with another WTRU if the other WTRU reserves a COT starting from a slot within its reserved COT. The WTRU may perform sidelink transmission to reserve a COT (e.g., in SCI) for its transmission in the future (e.g., periodic COT reservation). The WTRU may perform sensing before its reserved COT to determine whether there is a reservation before its reserved COT. The WTRU may trigger pre-emption checking to determine the availability of the reserved resource. Based on the existence of the other COT before the WTRU's reserved COT, the WTRU may perform LBT and transmission in the reserved COT (e.g., to access the COT) and share its COT with the other WTRU (e.g., FDM-based COT sharing) by indicating the other WTRU's ID in its transmission. The WTRU may leave a gap before the first slot of the other WTRU's COT, for example for the WTRU to perform LBT. In some embodiments, the other WTRU may continue to transmit in the COT using an orthogonal set of interlaces with the WTRU. In other embodiments, the other WTRU may resume its transmission if the WTRU finishes its COT. In this case, the other WTRU may perform type 2 LBT after the WTRU finishes its COT. If the WTRU does not detect another COT reservation before its COT reservation, the WTRU may perform LBT and transmission in the reserved COT without sharing its COT with another WTRU.

In some embodiments, for a reserved COT (MCSt), the WTRU may continue to perform LBT to acquire a COT after it fails to access the channel. Based on the duration of the acquired COT, the WTRU may determine whether to reserve the COT for the next period based on the old COT or the newly acquired COT. The WTRU may be configured to perform sidelink transmission to reserve a COT (e.g., in SCI) for its transmission in the future (e.g., periodic COT reservation). The WTRU may perform LBT to acquire the COT before the first slot of the reserved COT. If the WTRU fails LBT to transmit from the beginning of the first slot, the WTRU may continue to perform LBT to transmit on the subsequent occasions of the reserved COT. If the WTRU acquires the channel, it may perform transmissions in a new COT. If the duration of the newly acquired COT is greater than a configured or pre-configured threshold, the WTRU may reserve the COT for the next reservation period based on the newly acquired COT. Otherwise, the WTRU may reserve the COT for the next reservation period based on the previously reserved COT. The WTRU may perform transmissions in the new COT and may indicate the type of COT reservation in the SCI. Otherwise, the WTRU may declare LBT failure in the reserved COT. If the WTRU is in sidelink mode 2, it may trigger resource reselection to perform LBT and transmission in another COT. Otherwise, it may inform the network that it fails LBT.

In the embodiments described herein, channel access priority class (CAPC) is used to represent the LBT parameters used by the WTRU to access the channel. However, CAPC can be replaced by any other LBT parameter or parameters, such as Clear Channel Access duration, LBT type for channel access, CAPC, cyclic prefix extension (CPE) for the first transmission of the COT, contention window size, defer period (T_{d}), LBT energy detection threshold, and/or transmission power. Further, priority is used to describe one representative QoS parameter. However, priority can be replaced by other QoS parameters, including, for example, priority, latency, remaining packet delay budget, minimum communication range, cast type (e.g., unicast, groupcast, broadcast), type of traffic (e.g., periodic, aperiodic), and/or type of reservation (e.g., periodic, aperiodic). Further, high CAPC is used to describe a high priority channel access, which may be prioritized over low priority channel access. High QoS (e.g., high priority) may be used to describe a TB with prioritized transmission.

When it is mentioned herein that the WTRU may be configured or pre-configured with a threshold, the WTRU may be pre-configured with a threshold of a parameter, or the WTRU may receive a configuration (e.g., via radio resource control (RRC), system information block (SIB)) with a threshold of a parameter. Resource selection or re-selection may be used herein interchangeably with COT selection or re-selection. Similarly, resource may be used interchangeably with COT herein.

In the embodiments described herein, COT may be used to refer to a set of one or more slots, which may be contiguous in time. The WTRU may perform slot-based resource selection, in which the WTRU may select each individual slot for each transmission of a TB. For this case, the COT terminology may be used to describe a transmission/resource of the WTRU in one slot. In the embodiments described herein, the WTRU may perform multiple consecutive slot-based selection for multi-consecutive slot transmission (MCSt) of one or more TBs. Within the selected MCSt, the WTRU may allow other WTRUs to use one or more resources. The COT terminology may be used to describe the set of consecutive slots for one or more WTRUs to perform transmission.

A WTRU may determine to perform sidelink transmission (e.g., sidelink data, feedback, and synchronization). The set of parameters to access the channel and perform sidelink transmission may include one or any combination of a CCA duration, LBT type for channel access (e.g., LBT type 1, 2, 2A, 2B, 2C), CAPC, CPE for the first transmission of the COT, contention window size, which may include the current contention window (CWp), and/or the minimum and/or the maximum contention window associated with the channel access priority class p (e.g., CWₚ, CW_{min,p}, and CW_{max,p},.), the defer period (T_{d}), the LBT energy detection threshold to determine the availability of a channel, and transmission power.

A WTRU may perform one or more transmission in a COT. The WTRU may reserve the COT for future transmission, which may have a reservation period gap with the current COT. In some embodiments, the WTRU may reserve the COT for transmissions only. In some embodiments, the WTRU may reserve the resource for both LBT and transmission. For example, the WTRU may reserve one or more symbols before its transmission slot for LBT purposes. The WTRU may indicate the reserved duration for LBT and/or the duration for transmission. Such reservations may be indicated in the SCI.

In some embodiments, the WTRU may pre-select a COT to perform LBT and transmission. Before performing transmission in the preselected COT, the WTRU may perform resource re-evaluation, which may be used to determine the availability of the COT to perform LBT and transmission. The WTRU may then re-select another COT if the pre-selected COT is unavailable. In some embodiments, the WTRU may reserve a COT to perform LBT and transmission. Before performing transmission in the reserved COT, the WTRU may perform pre-emption checking, which may be used to determine the availability of the reserved COT to perform LBT and transmission. The WTRU may then reselect another COT if the reserved COT is unavailable.

The WTRU may determine whether to perform resource re-evaluation/pre-emption for one preselected/reserved COT based on one or any combination of the property or properties of the reserved COT (e.g., one or more LBT parameters used to access the COT, COT duration) and/or QoS associated with the COT. Regarding the property or properties of the reserved COT, for example, the WTRU may perform re-evaluation/pre-emption if the COT duration is smaller than a configured or pre-configured threshold. For example, the WTRU may perform re-evaluation/pre-emption if the CAPC is smaller than a configured or pre-configured threshold. Regarding the QoS associated with the COT, for example, the WTRU may perform pre-emption if the priority associated with the COT is larger than a configured or pre-configured threshold.

A WTRU may determine when to perform resource re-evaluation/pre-emption for a preselected/reserved COT based on the WTRU failing LBT to access one or more slot from the reserved COT. For example, the WTRU may trigger pre-emption checking if it fails to access the channel to perform transmission from the first slot of the COT. In some embodiments, the WTRU may reserve a multi-channel COT, which may include resources in multiple resource block (RB) sets. The WTRU may then perform re-evaluation/pre-emption to evaluate the availability of the COT. The UE may detect one or more RB sets as unavailable. The WTRU may then release the unavailable RB sets. The WTRU may then perform LBT and transmission in the set of available RB sets.

In some embodiments, a WTRU may determine whether one COT is blocked by another COT. For example, the WTRU may determine whether an earlier COT blocks LBT and transmission of a later COT based on a time gap between the end of the earlier COT and the first symbol of the later COT. The WTRU may determine that the earlier COT may block the later COT if they are overlapped in the time domain. If the two COTs are not overlapped, the earlier COT may block LBT and transmission of a later COT if the time gap is greater than a gap threshold. The WTRU may then re-select another COT to avoid inter-COT blocking. Otherwise, if the time gap is smaller than the gap threshold, the earlier COT may not block LBT and transmission of the later COT.

In some embodiments, the gap threshold may be fixed. For example, the gap threshold may be fixed as one slot regardless of the subcarrier spacing (SCS) configured or pre-configured for the resource pool. For example, if the gap between the end of the earlier COT and the first symbol of the later COT is at least one slot, the WTRU may consider that the earlier COT does not block the later COT. The WTRU may then perform LBT and transmission in the later COT. Otherwise, if the gap between the end of the earlier COT and the first symbol of the later COT is smaller than one slot, the WTRU may consider that the earlier COT blocks the later COT.

In some embodiments, the gap threshold may be configured or pre-configured in the resource pool. For example, the WTRU may be configured or pre-configured per resource pool with a gap threshold to determine whether the earlier COT blocks the later COT. For example, in a resource pool of 15 KHz SCS, the WTRU may be configured or pre-configured with a GAP threshold of one symbol. For another example, in a resource pool of 30 KHz, the WTRU may be configured or pre-configured with a GAP threshold of two symbols, and for a resource pool of 60 LHz, the WTRU may be configured or pre-configured with a GAP threshold of four symbols.

In some embodiments, the symbol duration and/or the SCS may be configured or pre-configured in the resource pool. For example, in a resource pool of 15 KHz SCS, the WTRU may determine the GAP threshold of one symbol. Alternatively, in a resource pool of 30 KHz, the WTRU may determine the GAP threshold of one slot.

In some embodiments, the gap threshold may be determined based on QoS (e.g., priority, remaining PDB) of the data to transmit in the COT. For example, the WTRU may be configured or pre-configured with one GAP threshold for each priority, and the WTRU may determine which GAP threshold to use based on the priority of the TB to transmit in the COT.

In some embodiments, the gap threshold may be determined based on one or more LBT parameters used to access the COT, such as the Clear Channel Access duration, the LBT type for channel access, the CAPC, the CPE for the first transmission of the COT, the contention window size, the defer period (T_{d}), the LBT energy detection threshold, and/or the transmission power. In one example, the WTRU may determine the GAP threshold based on the CAPC to perform LBT and access the COT. For example, the WTRU may be configured or pre-configured with one GAP threshold for each CAPC. The WTRU may then determine which GAP threshold to use based on the CAPC associated with the COT. In another example, the WTRU may determine the GAP threshold based on the LBT type to access the COT. For example, the WTRU may be configured or pre-configured with one GAP threshold for each LBT type. The WTRU may be configured or pre-configured with one GAP threshold for LBT type 1 and another GAP threshold for LBT type 2. The WTRU may then determine which GAP threshold to use based on the LBT type to access the COT. In another example, the WTRU may determine the GAP threshold based on the differ period (T_{d}) used to access the channel. For example, the WTRU may be configured or pre-configured with one GAP threshold for each differ period (T_{d}). The WTRU may then determine which GAP threshold to use based on the differ period (T_{d}) used to access the channel.

In some embodiments, the time gap between the end of the earlier COT and the first symbol of the later COT may be configured or pre-configured in the resource pool. For example, the WTRU may be configured or pre-configured with multiple time gaps (e.g., two) between the end of one transmission in a slot and the first symbol of the following slot, in which one time gap may be used for the transmissions in the middle of the COT, and another time gap may be used for the transmission at the end of the COT. The prior time gap may be used to maintain the COT, which may require the gap to be smaller than a certain value (e.g., 16 μs). The second time gap may be larger than the prior time gap to allow the other WTRU to successfully perform LBT and obtain the COT from the beginning of the subsequent slot.

In some embodiments, the time gap between the end of the earlier COT and the first symbol of the later COT may be determined based on an indication from the other WTRU. For example, the WTRU may perform sensing to determine the time gap between its reserved COT and a potential COT from another WTRU. The WTRU may determine whether there is any WTRU reserving a COT that may result in inter-COT blocking. The WTRU may perform sensing by decoding the SCI transmissions from other WTRUs. The SCI transmitted by another WTRU (e.g., a Tx WTRU decoded by sensing) may indicate one or any combination of the following information: the start of the of the COT and/or the end of the COT, the time gap between the end of the COT and the slot boundary of the following slot, and/or the frequency resource used in the COT. Regarding the start of the COT and/or the end of the COT, for example, a WTRU may indicate in one or more SCIs the first and/or the last slot of its COT. Regarding the time gap between the end of the COT and the slot boundary of the following slot, for example, the WTRU may determine the duration of the last transmission of the availability of the COT reservation in the subsequent slot. For example, the WTRU may use one transmission duration (e.g., the transmission may leave one symbol at the end of the slot) if there is no COT reservation in the subsequent slot. The WTRU may use another transmission duration (e.g., the transmission may leave multiple symbols at the end of the slot) if the WTRU detects a COT reservation in the subsequent slot. The transmission duration may be determined based on one or more parameters used by the other WTRU to access the channel and transmit in the subsequent slot (e.g., CAPC, priority of the data).

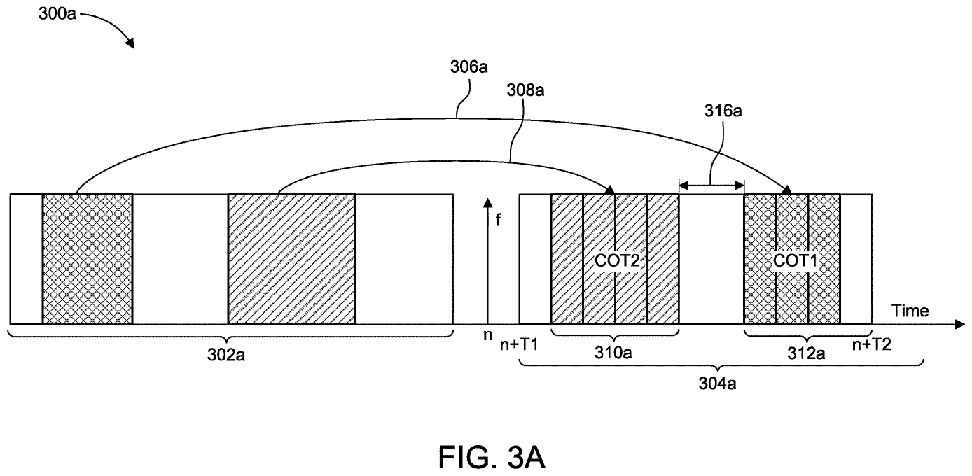

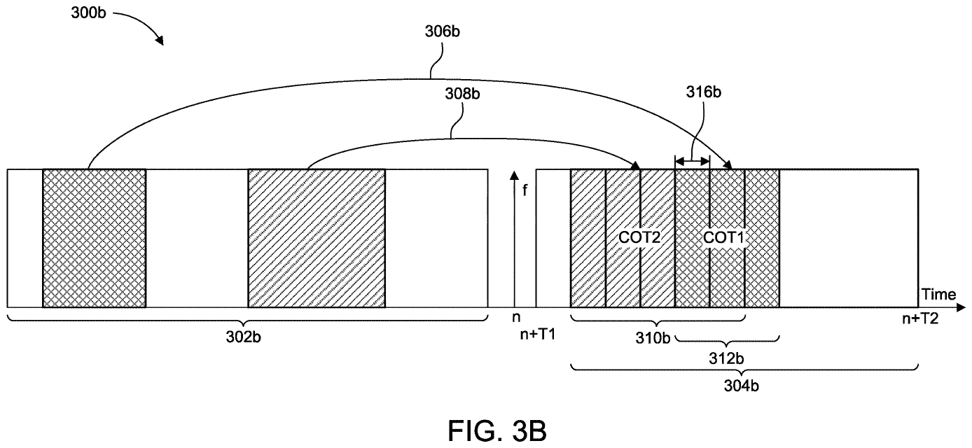

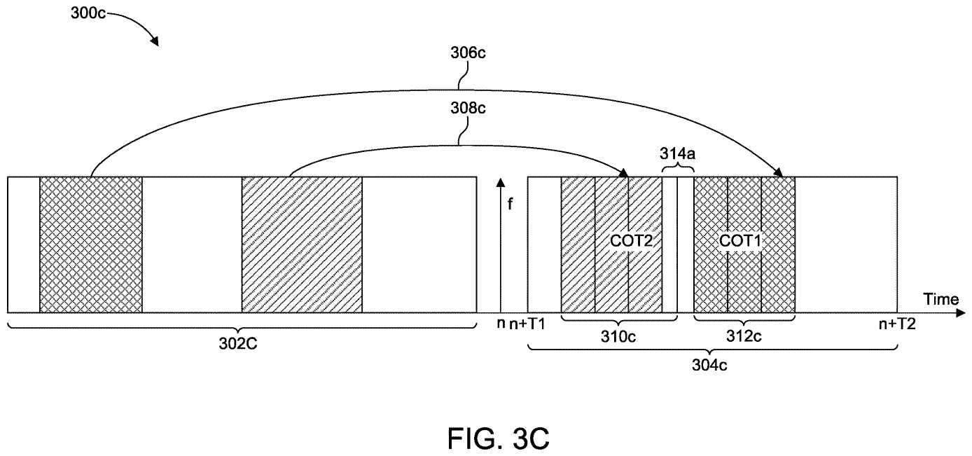

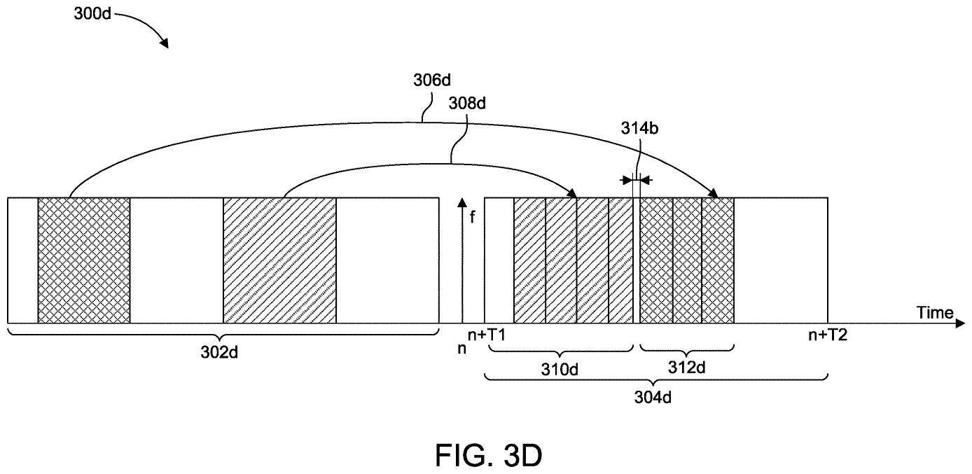

FIGS. 3A, 3B, 3C and 3D are diagrams showing examples where a WTRU may determine whether a second COT blocks a first COT in LBT and transmission. In each of these examples, the first COT is reserved by a first WTRU, and the second COT is reserved by a second WTRU.

FIG. 3A is a diagram 300A showing a first example of non-inter-COT blocking. In the example illustrated in FIG. 3A, in the sensing window 302a, the first WTRU reserves COT 312a (306a) for transmission during the upcoming resource selection window 304a and the second WTRU reserves COT 310a (308a) for transmission during the upcoming resource selection window 304a. In time, the first WTRU reserves the COT 312a before the second WTRU reserves the COT 310a; however, the COT 310a begins before the COT 312a. Accordingly, if the first WTRU did not check back after it reserved the COT 312a, a collision could occur. In this case, however, a gap 316a between the COT 310a and the COT 312a is two slots in duration, which is greater than the gap threshold, leaving enough time for the first WTRU to perform LBT before transmitting in the COT 312a. Both the first and second WTRUs may, therefore, transmit in their reserved COTs in this example.

FIG. 3B is a diagram 300B showing a first example of inter-COT blocking. In the example illustrated in FIG. 3B, in the sensing window 302b, the first WTRU reserves COT 312b (306b) for transmission in the upcoming resource selection window 304b and the second WTRU reserves COT 310a for transmission in the upcoming resource selection window 304b. In time, the first WTRU reserves the COT 312b before the second WTRU reserves the COT 310b; however, the COT 310b begins before the COT 312a. Accordingly, if the first WTRU did not check back after it reserved the COT 312b, a collision could occur. In this case, there is no gap between the COTs 312b and 310b, and the COTs 312b and 310b actually overlap in time (illustrated by the overlapping duration 316b in FIG. 3B). Accordingly, the “gap” between the COTs 310b and 312b is negative in duration and, therefore, is less than the gap threshold such that there is not enough time for the first WTRU to perform LBT before transmitting in the COT 312b. The first COT may, therefore, consider the second WTRU's reservation of COT 312b as blocking the first WTRU's reserved COT 312b such that both WTRUs cannot transmit in their reserved COTs without causing a collision.

FIG. 3C is a diagram 300C showing a second example of non-inter-COT blocking. In the example illustrated in FIG. 3C, in the sensing window 302c, the first WTRU reserves COT 312c (306c) for transmission during the upcoming resource selection window 304c and the second WTRU reserves COT 310c (308c) for transmission during the upcoming resource selection window 304c. In time, the first WTRU reserves the COT 312c before the second WTRU reserves the COT 310c; however, the COT 310c begins before the COT 312c. Accordingly, if the first WTRU did not check back after it reserved the COT 312c, a collision could occur. In this case, however, a gap 316c between the COT 310c and the COT 312c is less than one slot in duration, which, while smaller than the gap 316a in FIG. 3A yet is still greater than the gap threshold, leaving enough time for the first WTRU to perform LBT before transmitting in the COT 312c. Both the first and second WTRUs may, therefore, transmit in their reserved COTs in this example. In this example as well, the second WTRU may indicate, for example in one or more SCIs transmitted in the sensing window 302c, that the transmission duration in the last slot may result in a time gap greater than the GAP threshold.

FIG. 3D is a diagram 300D showing a second example of inter-COT blocking. In the example illustrated in FIG. 3D, in the sensing window 302d, the first WTRU reserves COT 312d (306d) for transmission in the upcoming resource selection window 304d and the second WTRU reserves COT 310d for transmission in the upcoming resource selection window 304d. In time, the first WTRU reserves the COT 312d before the second WTRU reserves the COT 310d; however, the COT 310d begins before the COT 312d. Accordingly, if the first WTRU did not check back after it reserved the COT 312d, a collision could occur. In this case, there is a gap between the COTs 312d and 310d; however, the gap 314b is smaller than the gap threshold such that there is not enough time for the first WTRU to perform LBT before transmitting in the COT 312d. The first COT may, therefore, consider the second WTRU's reservation of COT 312d as blocking the first WTRU's reserved COT 312d such that both WTRUs cannot transmit in their reserved COTs without causing a collision. In this example as well, the second WTRU may indicate, for example in one or more SCIs transmitted in the sensing window 302d that the transmission duration in the last slot may result in a time gap smaller than the GAP threshold.

In some embodiments, a WTRU may reserve a COT for future transmission that may have a duration of one or more slots. The WTRU may perform sensing before the reserved COT to determine the availability of the reserved COT. The WTRU may trigger resource selection or re-selection to re-select another COT if it detects another WTRU reserving another COT, which may result in an inter-COT blocking event. The WTRU may trigger resource selection or re-selection if its reserved COT blocks LBT and transmission of another COT. Alternatively, the WTRU may also trigger resource selection or re-selection if another COT blocks the WTRU in LBT and transmission in the reserved COT.

In some embodiments, a WTRU may detect an inter-COT blocking event, in which it may detect that two reserved COTs may block each other. The WTRU may send an indication (e.g., conflict indication, inter-COT blocking indication) to one WTRU, which may be used to indicate that the COT of the WTRU causes inter-COT blocking. The WTRU receiving the indication may trigger resource selection or re-selection to re-select the reserved COT.

In some embodiments, a WTRU may trigger resource selection and/or re-selection if its reserved COT blocks LBT and transmission of another WTRU. In some embodiments, the WTRU may determine whether to trigger resource selection and/or re-selection based on one or any combination of the QoS (e.g., priority, remaining PDB)/CAPC associated with its reserved COT, the QoS (e.g., priority, remaining PDB)/CAPC associated with the COT of the other WTRU, and/or the relative QoS (e.g., priority, remaining PDB)/CAPC between the two COTs. Regarding the QoS/CAPC associated with the WTRU's reserved COT, for example, the WTRU may trigger resource re-selection if the priority and/or CAPC associated with its reserved COT is smaller than a configured or pre-configured threshold. Otherwise, the WTRU may not trigger resource re-selection. Regarding the QoS/CAPC associated with the COT of the other WTRU, for example, the WTRU may trigger resource re-selection if the priority and/or CAPC associated with the reserved COT of the other WTRU is greater than a configured or pre-configured threshold. Otherwise, the WTRU may not trigger resource re-selection. Regarding the relative QoS/CAPC between the two COTs, for example, the WTRU may trigger resource re-selection if the priority and/or CAPC associated with its reserved COT is greater than the priority and/or CAPC associated with the reserved COT of the other WTRU. Otherwise, the WTRU may not trigger resource re-selection.

In some embodiments, the WTRU may trigger resource selection or re-selection to select or re-select a COT (e.g., one or more resources, one or more slots). The WTRU may first determine the set of COTs reserved by other WTRUs during the resource selection window. The WTRU may then prioritize selecting a COT, which may result in non-inter-COT blocking with a reserved COT from another WTRU. Specifically, the WTRU may prioritize selecting the COT, in which the time gap between the selected COT and the reserved COT from another WTRU are greater than the configured or pre-configured gap threshold. If the number of available COTs resulting in non-inter-COT blocking is not sufficient (e.g., the percentage of available COTs is smaller than a configured or pre-configured gap threshold, the WTRU may prioritize the COT not being blocked by other COT, in which the selected COT may block another reserved COT from another WTRU.

In some embodiments, a WTRU may perform pre-emption checking to determine the availability of a reserved COT. If the reserved COT results in inter-COT blocking, the WTRU may indicate the information regarding inter-COT blocking (e.g., in one or more subsequent transmission in the reserved COT). If the reserved COT results in inter-COT blocking, the WTRU may shorten the reserved COT, shift the reserved COT, re-select another COT and/or request another WTRU to modify the reserved COT.

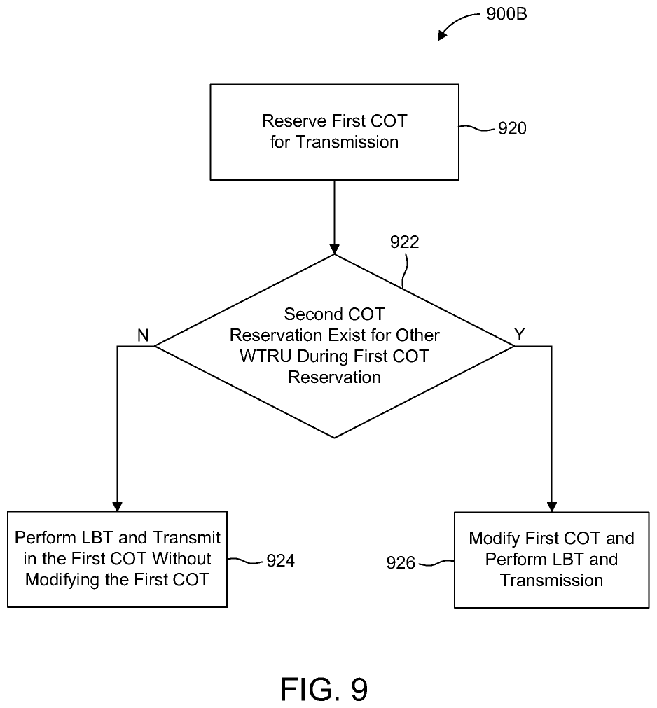

FIG. 9 is a flow diagram 900 of an example method of performing resource re-evaluation and/or pre-emption. In the example illustrated in FIG. 9, the method includes reserving a first COT for transmission (902). The WTRU may detect whether a second higher priority COT reservations exists for another WTRU (904). If not, the WTRU may perform LBT and transmit in the first COT (906). If so, the WTRU may modify the first COT and perform LBT and transmission (908), which may be performed prior to any colliding slots. In some embodiments, based on a remaining portion of the first COT being greater than a threshold without considering any colliding slots, the WTRU may shorten the first COT by releasing any colliding slots. The WTRU may perform LBT and transmission in any remaining portion of the shortened first COT and reserve another COT for data transmission. Based on the remaining portion of the first COT being less than the threshold without considering any colliding slots, the WTRU may perform LBT and transmit in the first COT without shortening the first COT.

In some embodiments, the WTRU may shorten its reserved COT in the event of inter-COT blocking. For example, the WTRU may perform LBT and transmission at the beginning of the COT. The WTRU may stop transmitting in the inter-COT blocking duration. The WTRU may not transmit in a duration at the end of the reserved COT. The WTRU may then indicate the information regarding the shortened COT (e.g., the initial transmission of the shortened COT, the end of the shortened COT, the duration of the shortened COT, the time gap between the end of its COT and the first symbol of the next slot) in one or more transmissions in the shortened COT. One or more information of the shortened COT may be indicated in the SCI or MAC CE.

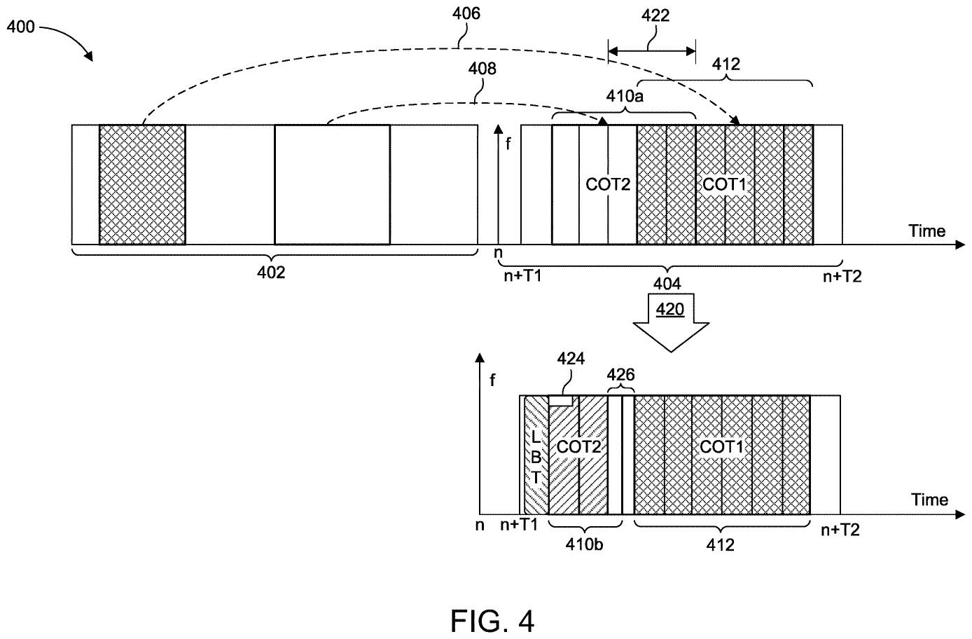

FIG. 4 is a diagram 400 of an example of inter-COT blocking with COT shortening. In the example illustrated in FIG. 4, in the sensing window 402, a first WTRU reserves a COT 412 (406) for transmission in the upcoming resource selection window 404. Also in the sensing window 402, a second WTRU reserves a COT 410 (408) for transmission in the upcoming resource selection window 404d and also detects the first WTRU's reservation of COT 410a, which may have inter-COT blocking with COT 412. For example, one or more transmissions of the second WTRU in COT 410b may block the first WTRU from performing LBT and transmission in COT 426. Based at least on detecting the inter-COT blocking, the second WTRU may determine to shorten its transmission in COT 410b. To do so, the second WTRU may trigger COT shorten (420) by an amount, which may be equal to any overlapping time between the COTs plus the time required for LBT (e.g., the gap threshold amount). This is illustrated in FIG. 4 as 316a, which indicates the inter-COT blocking duration, which also equals the COT shorten period. The LBT time for the COT 412 is illustrated in FIG. 4 as gap 426. The WTRU may stop transmitting in the COT shortened period. The WTRU may indicate (424) the time gap between the end of its COT 410b and the first slot of the subsequent slot 412 in one or more transmissions (e.g., in SCI) in the COT.

In some embodiments, the WTRU may shorten its reserved COT if one or more transmissions in the reserved COT are blocked by another WTRU (e.g., inter-COT blocking). For example, the WTRU may skip one or more transmissions at the beginning of its reserved COT. The WTRU may then perform LBT and transmission in the middle of its reserved COT. The WTRU may then indicate the information regarding the shortened COT (e.g., the initial transmission of the shortened COT, the end of the shortened COT, the duration of the shortened COT) in one or more transmissions in the shortened COT (e.g., in the SCI).

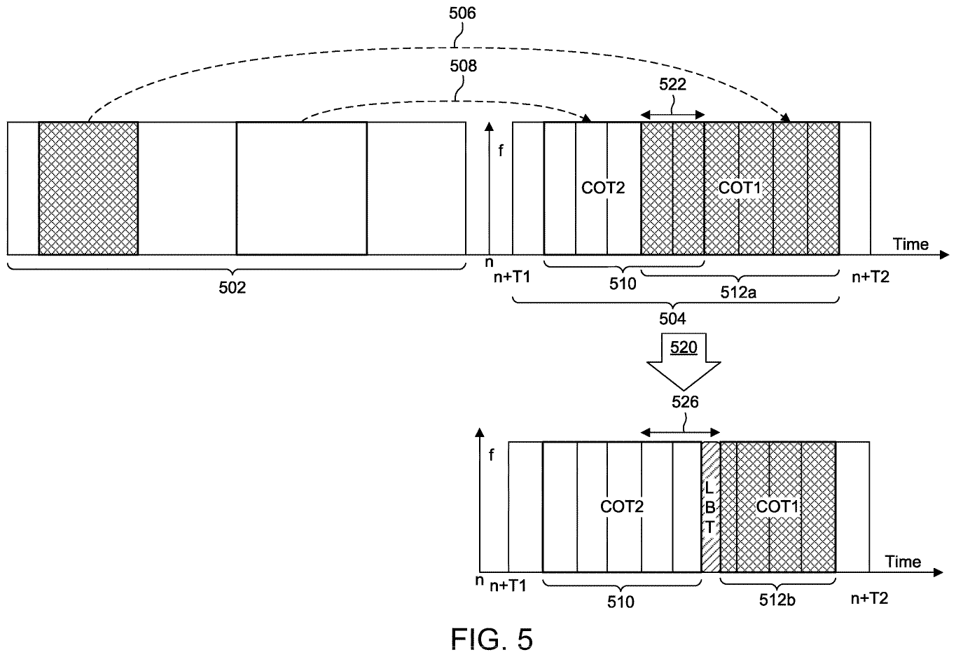

FIG. 5 is a diagram 500 of inter-COT blocking with COT shortening. In the example illustrated in FIG. 5, in the sensing window 502, a first WTRU may reserve COT 512a (506) for future transmission in the upcoming resource selection window 504. The first WTRU may perform sensing and may detect a second WTRU reserving COT 510 that may have inter-COT blocking with COT 512a. The first WTRU may determine to shorten its COT. To do so, the first WTRU may trigger (520) COT shortening and shift its initial transmission time in the COT 512b to the middle of the reserved COT 512b. The COT shortened period 526 may be equal to the inter-COT blocking duration 522.

The WTRU may determine whether to shorten its reserved COT if its reserved COT blocks LBT and transmission of another reserved COT from another WTRU based on one or more of QoS/CAPC associated with its reserved COT, QoS/CAPC associated with the other reserved COT, relative QoS/CAPC between the two COTs, buffer status of the WTRU and/or the remaining COT duration after the shortened COT. Regarding QoS/CAPC associated with the WTRU's reserved COT, for example, the WTRU may shorten its reserved COT if the priority associated with its reserved COT is smaller than a configured or pre-configured threshold. Otherwise, the WTRU may not shorten its reserved COT. Regarding QoS/CAPC associated with the other reserved COT, for example, the WTRU may shorten its reserved COT if the priority associated with the reserved COT of the other WTRU is larger than a configured or pre-configured threshold. Otherwise, the WTRU may not shorten its reserved COT. Regarding the relative QoSICAPC between the two COTs, for example, the WTRU may shorten its reserved COT if the priority of the data associated with its reserved COT is smaller than the priority of the data associated with the other WTRU's reserved COT. Otherwise, the WTRU may not shorten its reserved COT. Regarding the buffer status of the WTRU, for example, the WTRU may shorten its reserved COT if the amount of data in the buffer is smaller than a configured or pre-configured threshold. Otherwise, the WTRU may not shorten its reserved COT. Regarding the remaining COT duration after the shortened COT, for example, the WTRU may shorten its reserved COT if the remaining COT duration after the shortened COT is larger than a configured or pre-configured threshold. In some embodiments, the threshold may be configured or pre-configured per CAPC. For example, the WTRU may shorten its reserved COT if the remaining COT is sufficient to transmit the data in the buffer or if the remaining COT is sufficient to transmit a configured or pre-configured set of SLRBs/LCHs in the buffer.

In some embodiments, the WTRU may be configured or pre-configured with a minimum priority of other WTRU's reserved COT to shorten its reserved COT. For example, the WTRU may not shorten its reserved COT if the priority of the other WTRU's reserved COT causing inter-COT blocking is smaller than the minimum priority. The WTRU may then determine to shorten its COT if the priority of its reserved COT is smaller than the priority of the other WTRU's reserved COT.

In some embodiments, the WTRU may determine whether to shorten its reserved COT if the reserved COT is blocked by another WTRU. Such decision may be made based on one or more of the QoS/CAPC associated with its reserved COT, the QoS/CAPC associated with the other reserved COT, the relative QoS/CAPC between the two COTs, the buffer status of the WTRU and/or the remaining COT duration after the shortened COT. Regarding the QoS/CAPC associated with the WTRU's reserved COT, for example, if the remaining PDB of the TB is smaller than a configured or pre-configured threshold, the WTRU may shorten its reserved COT by selecting one time instance (e.g., one slot) in the middle of its reserved COT to perform LBT and transmission. Otherwise, if the remaining PDB is larger than the configured or pre-configured threshold, the WTRU may trigger resource reselection to reselect another COT to perform LBT and transmission. Regarding the QoS/CAPC associated with the other reserved COT, for example, the WTRU may shorten its reserved COT if the priority associated with the reserved COT of the other WTRU is larger than a configured or pre-configured threshold. Otherwise, the WTRU may request the other WTRU to shorten its COT. Regarding the relative QoS/CAPC between the two COTs, for example, the WTRU may shorten its reserved COT if the priority of the data associated with its reserved COT is smaller than the priority of the data associated with the other WTRU's reserved COT. Otherwise, the WTRU may request the other WTRU to shorten its COT. Regarding the buffer status of the WTRU, for example, the WTRU may shorten its reserved COT if the amount of data in the buffer is smaller than a configured or pre-configured threshold. Otherwise, the WTRU may reselect another COT. Regarding the remaining COT duration after the shortened COT, for example, the WTRU may shorten its reserved COT if the remaining COT duration after the shortened COT is larger than a configured or pre-configured threshold. Otherwise, the WTRU may reselect another COT to perform LBT and transmission.

In some embodiments, the WTRU may determine to shift its reserved COT upon detection of inter-COT blocking. For example, the WTRU may shift its reserved COT to align with another reserved COT. In some embodiments, the WTRU may shift its reserved COT to align with the prior reserved COT. In another approach, the WTRU may shift its reserved COT to align with the later reserved COT. Such COT shifting may help the WTRU avoid inter-COT blocking with the other reserved COT since, when the WTRU aligns the transmission time with another WTRU, two WTRUs may be able to access the channel simultaneously. The WTRU may reselect another set of interlaces to transmit in the shifted COT if the reserved set of interlaces collide with the set of reserved interlaces of the other WTRU.

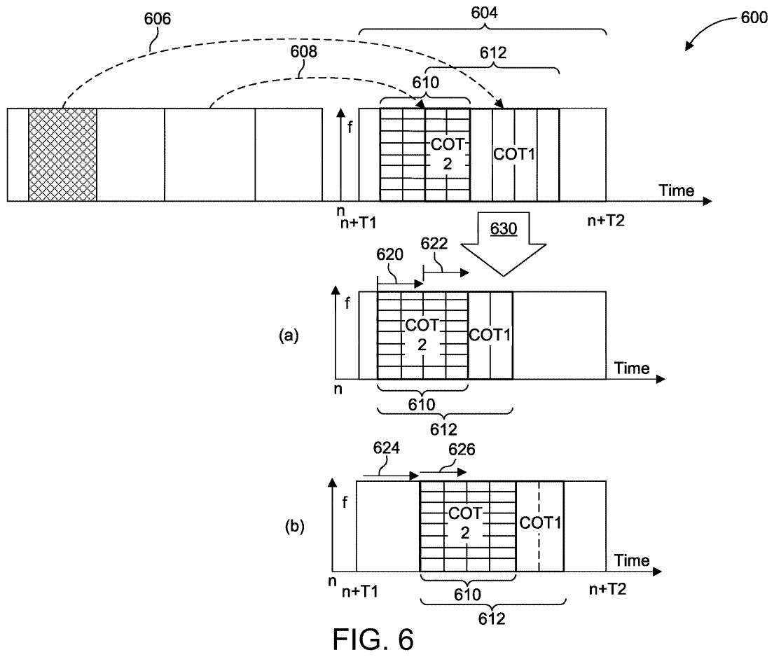

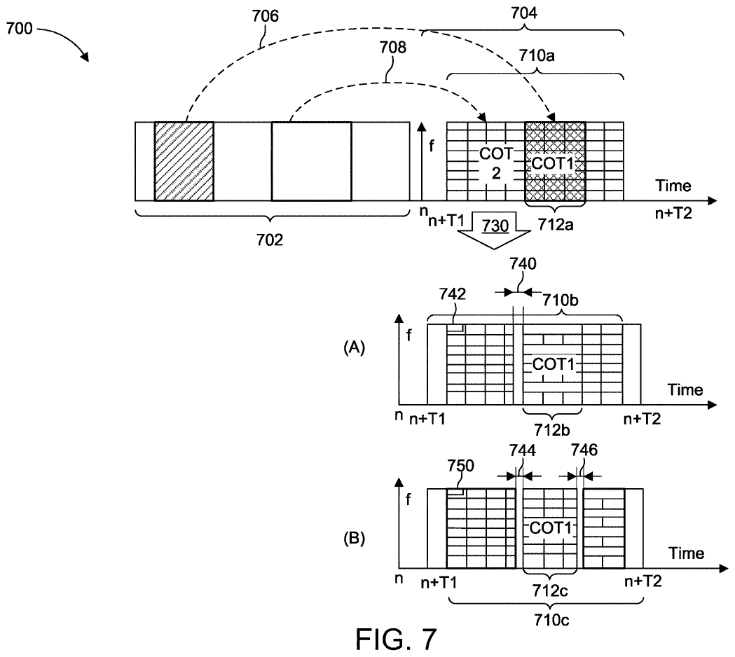

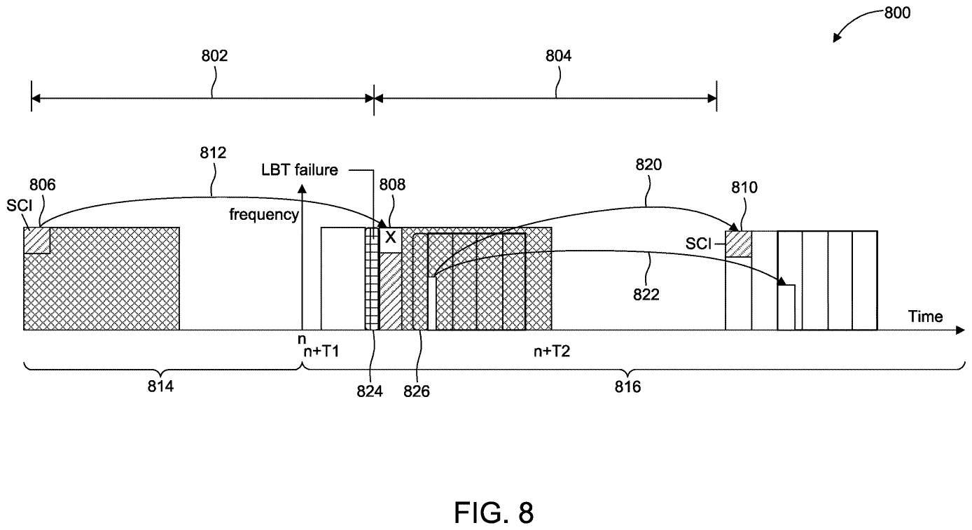

FIG. 6 is a diagram 600 of an example of COT-blocking with COT shifting. In the example illustrated in FIG. 6, in the sensing window 602, a first WTRU may reserve COT 612 (606) for future transmission in the upcoming resource selection window 604. The first WTRU may perform sensing and may detect a second WTRU reserving COT 610 that may have inter-COT blocking with COT 612. The first WTRU may trigger COT shifting (630) by either shifting its reserved COT 612 to align with the COT 610 or signal to the second WTRU to shift its reserved COT 610 to align with COT 612. Option (a) in FIG. 6 illustrates the scenario where the first WTRU shifts its COT 612 to align with the COT 610. In the illustrated example, the arrow 620 indicates the shifted COT 612 starting time, which has been shifted such that COTs 610 and 612 begin at the same time, and arrow 622 indicates the original starting time of COT 612. Option (b) in FIG. 6 illustrates the scenario where the second WTRU shifts its COT 610 to align with COT 612. In the illustrated example, the arrow 624 indicates the original starting time of COT 610, and the arrow 626 indicates the shifted COT 610 starting time, which has been shifted such that COTs 610 and 612 begin at the same time.

In embodiments in which a WTRU shifts its reserved COT to align with a reserved COT of another WTRU, the shifting WTRU may determine the value of one or more LBT parameters (e.g., the Clear Channel Access duration, the LBT type for channel access, the CAPC, the CPE for the first transmission of the COT, the contention window size, the defer period (T_{d}), the LBT energy detection threshold, the transmission power) to access the channel in the shifted COT based on one or more LBT parameters associated with the reserved COT of the other WTRU. For example, the other WTRU may indicate one or more parameters (e.g., CPE, CAPC) to access its reserved COT. The WTRU may then determine one or more LBT parameters to access the shifted COT based on one or more LBT parameters associated with the reserved COT of the other WTRU. For example, the other WTRU may indicate the CPE it uses to access the reserved COT. The WTRU may then use the same CPE to access the shifted COT to align channel access time with the other WTRU.

A WTRU may determine whether to shift its reserved COT to align its transmission with the reserved COT of another WTRU based on one or more of the starting time (e.g., starting slot) of the other COT that the WTRU targets to align transmission, the relative starting time between two COTs causing inter-COT blocking, the number of available interlaces in the shifted COT, whether the set of reserved interlaces in its COT collides with the set of reserved interlaces in the other WTRU's reserved COT, the QoS (e.g., priority, remaining PDB) of the data associated with its reserved COT, the QoS (e.g., priority, remaining PDB) of the data associated the reserved COT from the other WTRU causing inter-COT blocking, the relative QoS (e.g., priority, remaining PDB) of the data associated with the two COTs, one or more LBT parameters used to access the channel of its reserved COT, one or more LBT parameters used to access the channel of the other WTRU's reserved COT, and/or the relative LBT parameters to access the channel between its reserved COT and the other WTRU's reserved COT.

Regarding the starting time of the other COT the WTRU targets to align transmission, for example, the WTRU may align its COT with the reserved COT of the other WTRU if the COT starting time of the other WTRU is within a window. The first slot of the window may be based on the pre-emption checking time, and the last slot of the window may be based on the PDB of the data. Regarding the relative starting time between two COTs causing inter-COT blocking, in one example, the WTRU may shift its reserved COT if its reserved COT is after the other WTRU's reserved COT. In another example, the WTRU may shift its reserved COT if its reserved COT is prior to the other WTRU's reserved COT. Regarding the number of available interlaces in the shifted COT, for example, the WTRU may shift its reserved COT if the number of available interlaces in the shifted COT is greater than a configured or pre-configured threshold. Otherwise, the WTRU may not shift its COT to align its COT with the other WTRU.

Regarding whether the set of reserved interlaces in its COT collides with the set of reserved interlaces in the other WTRU's reserved COT, for example, a WTRU may shift its reserved COT to align its COT with another WTRU if the WTRU reserves non-overlapping interlaces in COT1 with the interlaces reserved by the other WTRU in COT2. Regarding the QoS of the data associated with its reserved COT, in one example, the WTRU may shift its reserved COT if the priority of the data associated with its reserved COT is smaller than a configured or pre-configured threshold. Otherwise, the WTRU may not shift its reserved COT. The WTRU may shift its COT if the reserved COT of the WTRU is prior to the reserved COT of the other WTRU. This approach may help the WTRU shift its reserved COT to avoid inter-COT blocking with a COT associated with a higher priority transmission. In another example, the WTRU may shift its reserved COT if the priority of the data associated with its reserved COT is larger than a configured or pre-configured threshold. Otherwise, the WTRU may not shift its reserved COT. The WTRU may shift its COT if the reserved COT of the WTRU is after the reserved COT of the other WTRU. This approach may help the WTRU avoid inter-COT blocking for its high priority data transmission.

Regarding QoS of the data associated with the reserved COT from the other WTRU causing inter-COT blocking, in one example, the WTRU may shift its reserved COT (e.g., to align with the COT of the other WTRU) if the priority of the data associated with the other WTRU's reserved COT is smaller than a configured or pre-configured threshold. The WTRU may shift its COT if the reserved COT from the other WTRU is prior to its reserved COT. In another example, the WTRU may shift its reserved COT (e.g., to align with the COT of the other WTRU) if the priority of the data associated with the other WTRU's reserved COT is larger than a configured or pre-configured threshold. Otherwise, the WTRU may not shift its reserved COT. This may be applicable if the reserved COT of the WTRU is after the reserved COT of the other WTRU.

Regarding the relative QoS of the data associated with the two COTs, in one example, the WTRU may shift its reserved COT if the priority of the data associated with its reserved COT is lower than the priority of the data associated with the other WTRU's reserved COT. The WTRU may shift its reserved COT if its reserved COT is prior to the reserved COT of the other WTRU with higher priority. In another example, the WTRU may shift its reserved COT if the priority of the data associated with its reserved COT is higher than the priority of the data associated with the other WTRU's reserved COT. The WTRU may shift its reserved COT if its reserved COT is after to the reserved COT of the other WTRU with lower priority.

The one or more LBT parameters may include, for example, the Clear Channel Access duration, the LBT type for channel access, the CAPC, the CPE for the first transmission of the COT, the contention window size, the defer period (T_{d}), and/or the LBT energy detection threshold, and/or the transmission power used to access the channel of its reserved COT. For example, the WTRU may shift its reserved COT if the CAPC of the WTRU is smaller than a configured or pre-configured threshold. Otherwise, the WTRU may not shift its reserved COT. Regarding one or more LBT parameters used to access the channel of the other WTRU's reserved COT, for example, the WTRU may shift its reserved COT (e.g., to align with the COT of the other WTRU) if the CAPC associated with the reserved COT of the other WTRU is smaller than a configured or pre-configured threshold. Otherwise, the WTRU may not shift its reserved COT for COT alignment.

Regarding the relative LBT parameters to access the channel between its reserved COT and the other WTRU's reserved COT, for example, if the reserved COT of the WTRU is before the reserved COT of the other WTRU, the WTRU may shift its reserved COT if the CAPC associated with its COT is smaller than the CAPC associated with other WTRU's reserved COT. For example, the WTRU may shift its reserved COT to align with the other WTRU's reserved COT if its maximum configured or pre-configured CPE to access the channel is larger than or equal to the maximum configured or pre-configured CPE of the other WTRU for COT alignment. This approach may be motivated to help the WTRU access the channel sooner or at the same time with the other WTRU.

In some embodiments, the WTRU may detect multiple reserved COTs within its resource selection window. The WTRU may then determine one reserved COT from another WTRU to align transmission of its reserved COT. The WTRU may determine which reserved COT to align its COT with based on one or more of the CPE used in the reserved COT, the CAPC associated with the other WTRU's reserved COT and/or the QoS/CAPC associated with its reserved COT, and/or the gap to its reserved COT. Regarding the CPE used in the reserved COT, for example, the WTRU may select the reserved COT having the same CPE as its reserved COT. Regarding the QoS/CAPC associated with the other WTRU's reserved COT and/or the QoS/CAPC associated with its reserved COT, for example, the WTRU may select the reserved COT having lowest QoS/CAPC to align its reserved COT. For another example, the WTRU may select the reserved COT having the highest QoS/CAPC to align its reserved COT. Regarding the gap to its reserved COT, for example, the WTRU may select the nearest COT to align its COT. For example, the WTRU may select the earliest COT to align its COT.

In some embodiments, a WTRU may detect inter-COT blocking, and the WTRU may indicate such inter-COT blocking event to one or both WTRUs. In some embodiments, the WTRU may indicate inter-COT blocking to the WTRU transmitting the prior COT. In some embodiments, the WTRU may indicate inter-COT blocking to the WTRU transmitting the later COT. In some embodiments, the WTRU may indicate the inter-COT blocking to the WTRU with lower priority, or lower CAPC. Such indication may be transmitted in PSFCH. The WTRU may implicitly request one WTRU to modify the reserved COT or request the WTRU to release the reserved COT.

In some embodiments, the WTRU may trigger resource selection or re-selection to select or re-select a COT (e.g., one or more resources, one or more slots). The WTRU may first determine the set of COTs reserved by other WTRUs during the resource selection window. The WTRU may then prioritize selecting a COT to align with the other reserved COT. For example, the WTRU may select a starting slot to be the same as the starting slot of a reserved COT in the resource selection window. The WTRU may select the reserved COT to align based on one or more LBT parameters (e.g., the Clear Channel Access duration, the LBT type for channel access, the CAPC, the CPE for the first transmission of the COT, the contention window size, the defer period (T_{d}), the LBT energy detection threshold, the transmission power) associated with its COT, one or more LBT parameters associated with the other WTRU's reserved COT, and/or the earliest COT in the resource selection window having a number of available interlaces being greater than a configured or pre-configured threshold.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A wireless transmit/receive unit (WTRU) comprising:
a processor; and
a transceiver,
wherein the processor and the transceiver are configured to:
reserve a first channel occupancy time (COT) for a transmission, detect a reserved second COT for an other WTRU,
determine that the reserved second COT overlaps the reserved first COT and
modify the reserved first COT based on the determination,
perform listen-before-talk (LBT), and
send the transmission in the modified reserved first COT.

2-18. (canceled)

19. The WTRU of claim 1, wherein:
the reserved first COT is reserved for a first duration,
the reserved second COT overlaps the reserved first COT by an overlap duration, and
the processor and the transceiver are further configured to:
based on the first duration, less the overlap duration, being less than a threshold duration, modify the reserved first COT by shortening the first duration.

20. The WTRU of claim 19, wherein the processor and the transceiver are further configured to shorten the first duration of the reserved first COT by the overlap duration.

21. The WTRU of claim 20, wherein:
the processor and the transceiver are further configured to perform LBT during the shortened reserved first COT.

22. The WTRU of claim 20, wherein the processor and the transceiver are further configured to shorten the first duration by releasing overlapping slots.

23. The WTRU of claim 20, wherein:
the transmission comprises sidelink control information (SCI) indicating a reservation of a third COT for a data transmission, and
the transceiver and the processor are further configured to send the data transmission in the reserved third COT.

24. The WTRU of claim 19, wherein the processor and the transceiver are further configured to:
based on the first duration, less the overlap duration, being greater than or equal to the threshold duration, modify the reserved first COT by shifting a start time of the transmission to a middle portion of the reserved first COT.

25. The WTRU of claim 24, wherein the processor and the transceiver are further configured to:
based on an interlace reserved for the transmission within the reserved first COT overlapping an interlace associated with the reserved second COT, select another interlace within the reserved first COT that does not overlap the interlace associated with the reserved second COT.

26. The WTRU of claim 1, wherein the processor and the transceiver are further configured to reserve the first COT for the transmission by sending a sidelink transmission.

27. The WTRU of claim 1, wherein the processor and the transceiver are further configured to determine that the reserved second COT overlaps the reserved first COT and is a higher priority COT by triggering pre-emption checking.

28. A method, implemented in a wireless transmit/receive unit (WTRU), the method comprising:
reserving a first channel occupancy time (COT) for a transmission;
detecting a reserved second COT for an other WTRU that overlaps the reserved first COT and is associated with a higher priority transmission;
modifying the reserved first COT based on the detection;
performing listen-before-talk (LBT); and
sending the transmission in the modified reserved first COT.

29. The method of claim 28, wherein:
the reserved first COT is reserved for a first duration,
the reserved second COT overlaps the reserved first COT by an overlap duration, and
the method further comprises:
based on the first duration, less the overlap duration, being less than a threshold duration, modifying the reserved first COT by shortening the first duration.

30. The method of claim 28, further comprising shortening the first duration of the reserved first COT by the overlap duration.

31. The method of claim 30, further comprising performing LBT during the shortened reserved first COT.

32. The method of claim 30, further comprising shortening the first duration by releasing overlapping slots.

33. The method of claim 30, wherein:
the transmission comprises sidelink control information (SCI) indicating a reservation of a third COT for a data transmission, and
the method further comprises sending the data transmission in the reserved third COT.

34. The method of claim 29, further comprising:
based on the first duration, less the overlap duration, being greater than or equal to the threshold duration, modifying the reserved first COT by shifting a start time of the transmission to a middle portion of the reserved first COT.

35. The method of claim 34, further comprising:
based on an interlace reserved for the transmission within the reserved first COT overlapping an interlace associated with the reserved second COT, selecting another interlace within the reserved first COT that does not overlap the interlace associated with the reserved second COT.

36. The method of claim 28, further comprising reserving the first COT for the transmission by sending a sidelink transmission.

37. The method of claim 28, further comprising determining that the reserved second COT overlaps the reserved first COT and is a higher priority COT by triggering pre-emption checking.
